(19) United States
(12) Patent Application Publication
(10) Pub. No.: US 2007/0034658 A1
(43) Pub. Date: Feb. 15, 2007

(54) Vehicle accessory rack

(75) Inventors: Terry N. Clark, Chicago, IL (US); David Cooper, Chicago, IL (US); John Stuart, Chicago, IL (US)

Correspondence Address: BANNER & WITCOFF, LTD., TEN SOUTH WACKER DRIVE, SUITE 3000, CHICAGO, IL, 60606, US

(73) Assignees: Terry N. Clark, Chicago, IL (US); Cooper Technica, Inc., Chicago, IL (US)

(21) Appl. No.: 11/200,814

(22) Filed: Aug. 10, 2005

(51) Int. Cl. B60R 11/00; B60R 9/00

(52) U.S. Cl. 224/517; 224/924

(57) ABSTRACT

An accessory rack for mounting on a vehicle is described. In an embodiment, the accessory rack includes an anchor that mounts to the frame and a stand that is supported by the anchor so as to provide a strong yet compact accessory rack. The small size provides potential benefits in the reduction of fuel consumption and/or reductions in wind noise in the event the user does not remove the accessory rack from the vehicle during periods of disuse. The accessory rack may include a stand configured to support standard sized carriers while providing improved ergonomics during installation of objects onto the carrier.

### BACKGROUND OF THE INVENTION

1. Field of the Invention

The present invention relates to the field of vehicle accessories, more specifically to an accessory rack for mounting on a vehicle.

2. Description of Related Art

The use of accessory racks for vehicles is known. Generally, the accessory rack is first mounted on the vehicle and then various carriers may be mounted on the accessory rack. While there are numerous variations, a common arrangement is for the accessory rack to use two roof mounts connected together by a horizontal bar. By mounting two horizontal bars a distance apart, a carrier may be mounted to the two bars and objects may be carried. Carriers come in a variety of shapes and sizes and range from specialized carriers configured to hold bicycles or skis to more general purpose carriers configured to hold luggage or containers. While existing accessory racks are configured to mount a number of vehicles, they are generally unsuitable for certain types of sports cars and convertibles because on such vehicles the body, particularly the roof, is not configured to support the weight of an object mounted thereto.

Certain accessory racks have been mounted to the rear of vehicles, somewhat like a trailer hitch, but these accessory racks are poorly suited to carry objects longer than the vehicle is wide. Therefore, vehicles exist that have no suitable way to carry a longer object such as a kayak. Furthermore, these hitch-like accessory racks, which are most often used for bicycles, often do not securely support a bicycle in a manner that prevents the bicycle from bumping the body of the vehicle.

In addition, accessory racks are mounted on bumpers, trailer hitches, spare tire mounts or lift gate hinges. While these accessory racks have been somewhat effective for certain purposes, they are unsuited for a vehicle that does not have a bumper, trailer hitch, spare tire mount or lift gate. For example, sports cars with tubular space frames and fiberglass or plastic bodies are sometimes unable to accept any existing accessory rack.

Furthermore, many accessory racks take up substantial room when being stored and are difficult to remove from the vehicle. Therefore it is common for the accessory rack to be left on the vehicle even when not it use, potentially causing significant reductions in fuel economy.

### BRIEF SUMMARY OF THE INVENTION

In an embodiment, an accessory rack includes a first support and a second support.

The first support is mounted to a structural hard point and extends through the vehicle body. The second support mounts to a second structural hard point located rearward of the first structural hard point. The second support also extends through the vehicle body. In an embodiment, the first and the second support are configured to accept a variety of carriers. In an embodiment, the first and second support includes an anchor that is configured to mount to the structural hard points and a support mounted to the anchor, the support configured to accept a carrier.

### BRIEF DESCRIPTION OF THE DRAWINGS

The present invention is illustrated by way of example and not limited in the accompanying figures in which like reference numerals indicate similar elements and in which:

FIG. 1 illustrates an embodiment of an accessory rack mounted on a vehicle in accordance with an aspect of the present invention.

FIG. 2 illustrates an embodiment of a simplified frame of a vehicle.

FIG. 3 illustrates an embodiment of an accessory rack mounted to a frame in accordance with an aspect of the present invention.

FIG. 4 illustrates an alternative embodiment of an accessory rack mounted to a frame in accordance with an aspect of the present invention.

FIG. 5 illustrates an embodiment of a front support in accordance with an aspect of the present invention.

FIG. 6a-6b illustrate front and side views of a rear anchor in accordance with an aspect of the present invention.

FIG. 7a-7b illustrate front and side views of a horizontal stand in accordance with an aspect of the present invention.

FIG. 8 illustrates a faux anchor in accordance with an aspect of the present invention.

FIG. 9 illustrates a method of installation in accordance with an aspect of the present invention.

### DETAILED DESCRIPTION OF THE INVENTION

In embodiments of the present invention, an accessory rack is provided that has the potential to provide a reduced impact on vehicle fuel consumption and undesirable wind noise generation. As is known, the mounting of an accessory rack on a vehicle generally causes the vehicle to consume additional fuel during use, especially at higher rates of speed. This is expected and somewhat difficult to avoid while transporting an object with the accessory rack. However, when the accessory rack is not being used it would be beneficial to minimize any increase in fuel consumption caused by the failure of the user to remove the accessory rack while not in use.

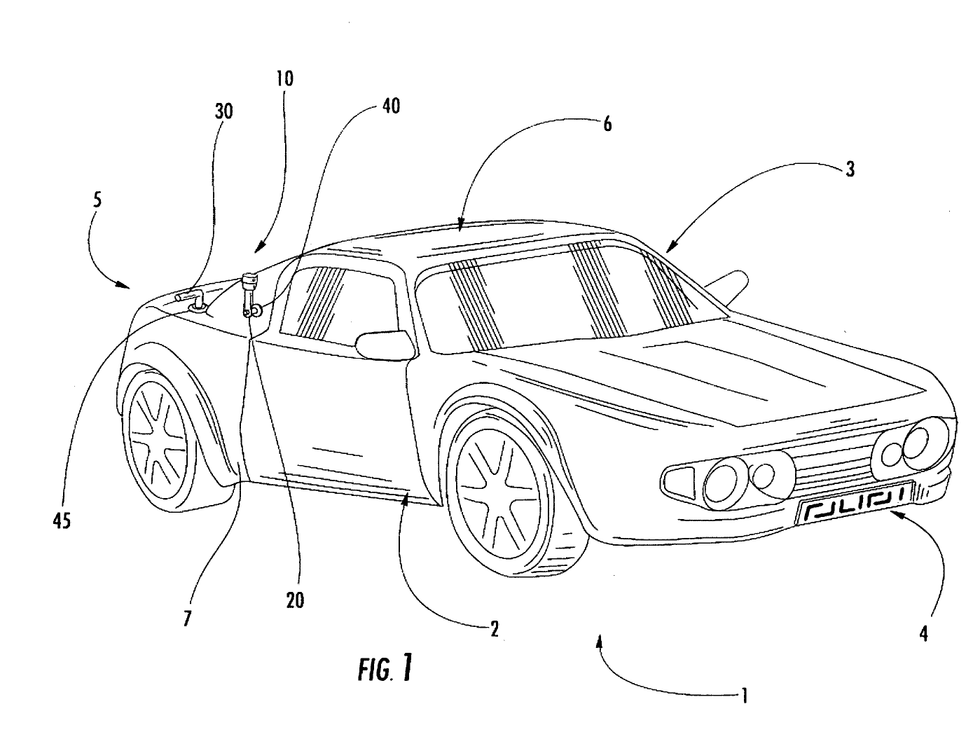

Turning to FIG. 1, a vehicle 1 is depicted. The vehicle 1 includes a first side 2, a second side 3, a front 4, a rear 5 and a roof 6. The exterior portion or skin of the vehicle 1 may be referred to as a body 7. Mounted through the body 7 on the first side 2 is an accessory rack 10. The accessory rack 10 includes a front support 20 and a rear support 30. As the front and rear supports 20, 30 extend through the body 7, a grommet 40 seals the front support 20 to the body 7 and a grommet 45 seals the rear support 30 to the body 7.

As can be appreciated from FIG. 1, the accessory rack 10 is configured to be mounted to the vehicle 1 in a particular location. The depicted mounting point of the accessory rack 10, while not required, has several potential advantages. For example, the lower mounting height (depicted as being below the roof of the vehicle) reduces the effective height of the vehicle when the object is installed on the accessory rack 10. The lower mounting height also makes it easier to install the object onto the accessory rack 10. The ease of mounting of an object to the accessory rack 10 is further amplified because the accessory rack 10 is on the first side 2 of the vehicle 1 rather than over the roof 6 between the first and second sides 2, 3 of the vehicle 1.

Locating the accessory rack 10 substantially behind the passenger compartment of the vehicle 1 may also reduce the observation of noises in the passenger compartment caused by the carrying of an object that may have less than an ideal shape from the standpoint of generating wind noise.

It should be noted that in an embodiment, the body 7 will be provided without holes configured to accept the fronts and rear supports 30, 40. Therefore, two holes may be formed in the body 7 so that the supports 30, 40 can be mounted accordingly. In an embodiment the holes in the body 7 may be formed by drilling although other known methods of generating holes in the body 7 may also be used in other embodiments.

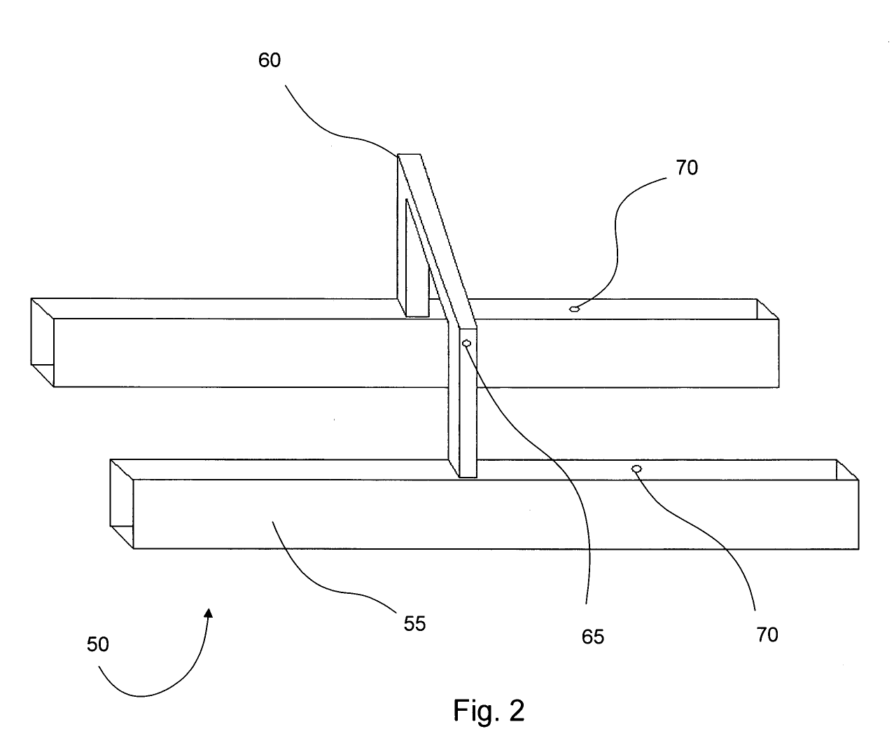

Turning to FIG. 2, a simplified portion of a frame 50 is depicted. As can be appreciated, the frame 50 of a vehicle will vary greatly depending on the design of the vehicle and the purpose of the vehicle. Therefore, FIG. 2 is merely for purposes of illustration with the understanding that an actual vehicle frame will have a somewhat different configuration. It is also noted that some care should be used when deciding where to mount to the frame so as to avoid inadvertent structural damage to the vehicle.

As depicted, the frame 50 includes a member 55 supporting a cross-member 60. In an embodiment, the cross-member 60 may be a roll bar. A first structural hard point 65 is depicted as being positioned on the cross-member 60. A second structural hard point 70 is provided on the member 55. These structural hard points 65, 70 may be provided on the frame 50 for the purpose of accepting an accessory rack or may be holes or points on the frame 50 that provide suitable places to support an accessory rack. Thus, in an embodiment the structural hard points 65, 70 will be existing features on the frame 50 that are suitably located so as to provide adequate support for an accessory rack.

As can be appreciated, the structural hard points 65, 70 provide sufficient rigidity to support the accessory rack 10. It should be noted that the structural hard points may be provided in a variety of locations depending on the design the vehicle, such as, but not limited to, seatbelt anchors, strut braces, roll bars, and frame rails. The structural hard points may be available in the vehicle as designed or may require modification of the existing vehicle before the structural hard points are configured to accept the supports 20, 30.

It should be noted that the frame 50 may include additional components and may be made in a number of methods and out of a number of different materials. As the particular shape and materials used to provide the frame are not critical to the present invention, the frame construction will not be discussed further.

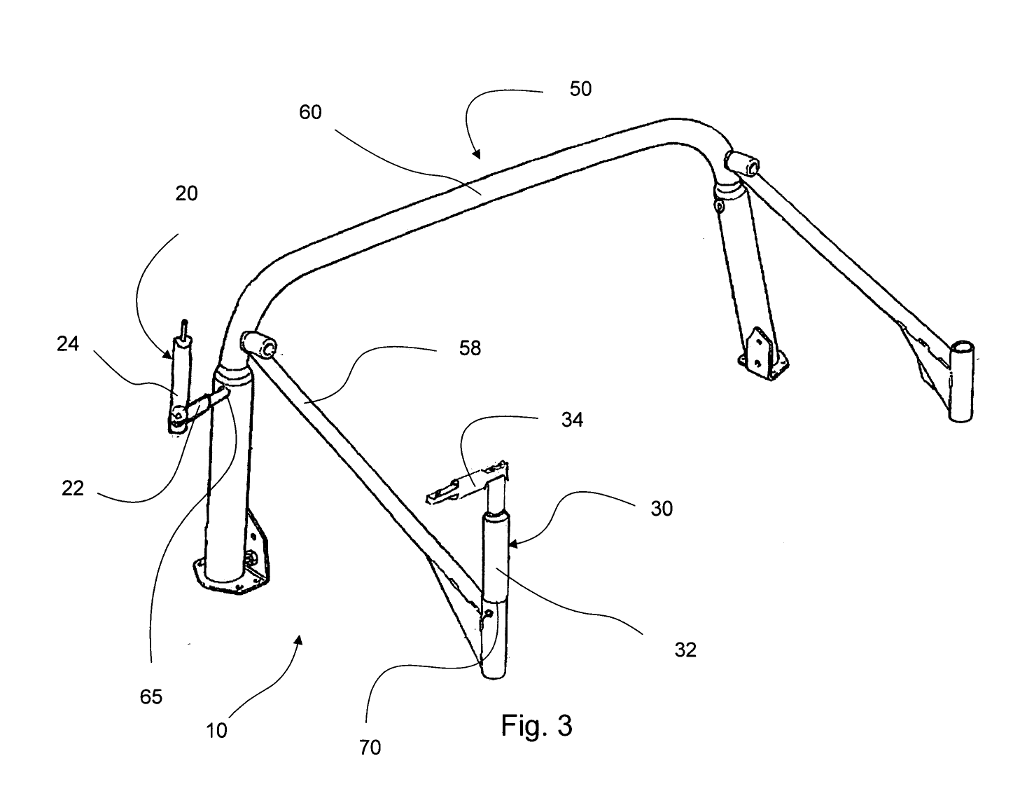

Turning to FIG. 3, an exemplary embodiment of a portion of the frame 50 is depicted with the accessory rack 10 mounted to a cross-member 60. For the sake of clarity, the body of the vehicle is omitted. The accessory rack 10 comprises the front support 20 and the rear support 30. In operation, the front support 20 and the rear support 30 would extend through the body 7 (FIG. 1).

As depicted, the front support 20 is mounted to the first structural hard point 65 and comprises a front anchor 22 and a vertical stand 24. In an embodiment, the front anchor 22 mounts to the cross member 60 and extends through the body 7 (FIG. 1).

While numerous methods of mounting the front support 20 to the first structural hard point 65 are possible, as depicted the front anchor 22 mounts to the cross-member 60 through the first structural hard point 65. The vertical stand 24 then mounts to the front anchor 22. Thus, as depicted the front anchor 22 mounts to the first structural hard point 65 at a horizontal inclination.

The rear support 30 is depicted mounted to the second structural hard point 70 that is provided on the support bar 58. In an embodiment the rear support 30 comprises a rear anchor 32 that supports a horizontal stand 34. As depicted, the rear anchor 32 is mounted to the support bar 58 at the second structural hard point 70 and then the horizontal stand 34 is mounted on the rear anchor 32. Thus, FIG. 3 provides a method for mounting a front and rear support to structural hard points of a vehicle.

It should be noted that numerous variations in how the various components interface are possible and considered within the scope of the present invention. However, the configuration depicted in FIG. 3 has a certain advantage in that the front support 20 connects horizontally to the frame 50 and the rear support 30 connects vertically to the frame 50. This mounting configuration helps ensure the accessory rack 10 as a whole is more secure because of the strength of the mounting in different directions provides addition securing of the relevant degrees of freedom. Thus, the rear support 30 helps ensure that the accessory rack 10 is secure in the vertical direction and the front support 20 helps ensure that the accessory rack 10 is secure in the horizontal direction. This can be advantageous over conventional accessory racks that mount to a vehicle in the same direction and therefore cannot provide the additional strength of an accessory with two substantially perpendicular mountings.

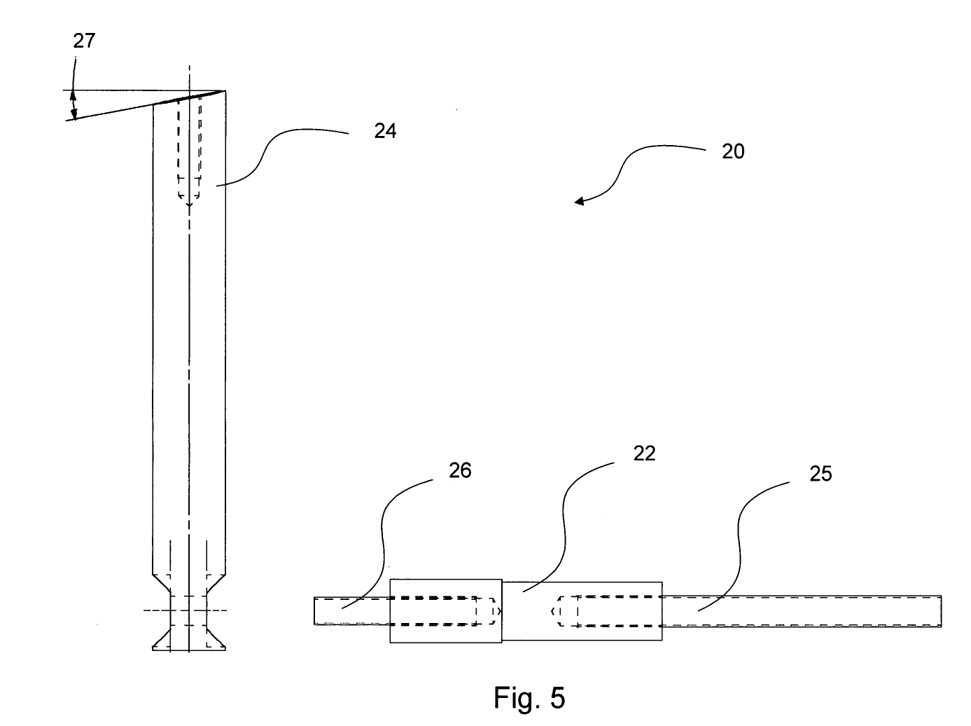

Turning to FIG. 5, additional details of the embodiment of the front support 20 depicted in FIG. 3 are provided. The front anchor 22 is depicted in an exploded view with the vertical stand 24. As depicted, the front anchor 22 is configured to accept a first double-sided stud 25 and a second doubled-sided stud 26. In an embodiment, the front anchor is machined and drilled and threaded on each end. A black anodized coating or powder coating may then be added. The doubled-sided stud 25 is configured to mount to the structural hard point 65 (FIG. 3) and the double-sided stud 26 is configured to aid in mounting the vertical stand 24 to the front anchor 22.

In an embodiment, the double-sided stud 25 may be about 100 mm long and may be inserted through the structural hard point 65. Thus, when mounting to a tubular section the stud 25 may be configured to interface with two sides of the tubular section so as to increase the strength of the mounting. On the other end of the front anchor 22, the length of the doubled sided stud 26 may be configured to be suitable for accepting a fastener. A nut (not shown) may then be used to fasten the vertical stand 24 to the front anchor 22 and the vertical stand 24 may be cut at an angle 27.

The angle 27, if provided, may be 8 and 10 degrees, depending on the orientation and may be configured to align the accessory rack 10 with the slope of the vehicle 1 when the accessory rack 10 is installed.

Thus, in an embodiment, one or more threaded holes may be provided in the first structural hard point 65 for accepting the double-sided stud 25. The double-sided stud 25 may be mounted in the threaded hole(s) and the front anchor 25 may be mounted to the double-sided stud 25. The threaded stud 26 may then be mounted to the front anchor 22 as shown. A vertical stand 24 may then be mounted to the threaded stud 26 with a fastener (not shown). The configuration discussed herein has the advantage of being relatively easy to mount to the frame of a vehicle that is not preconfigured to accept such a support.

Referring back to FIG. 1, the grommets 40, 45 may be installed before, during or after the installation of the front support 20 and rear support 30. For example but without limitation, the double-sided stud 25 may be installed first and then the grommet 40 may be mounted to the hole in the body 7. The front anchor 20 may then be installed and the rest of the front support may be installed as discussed above.

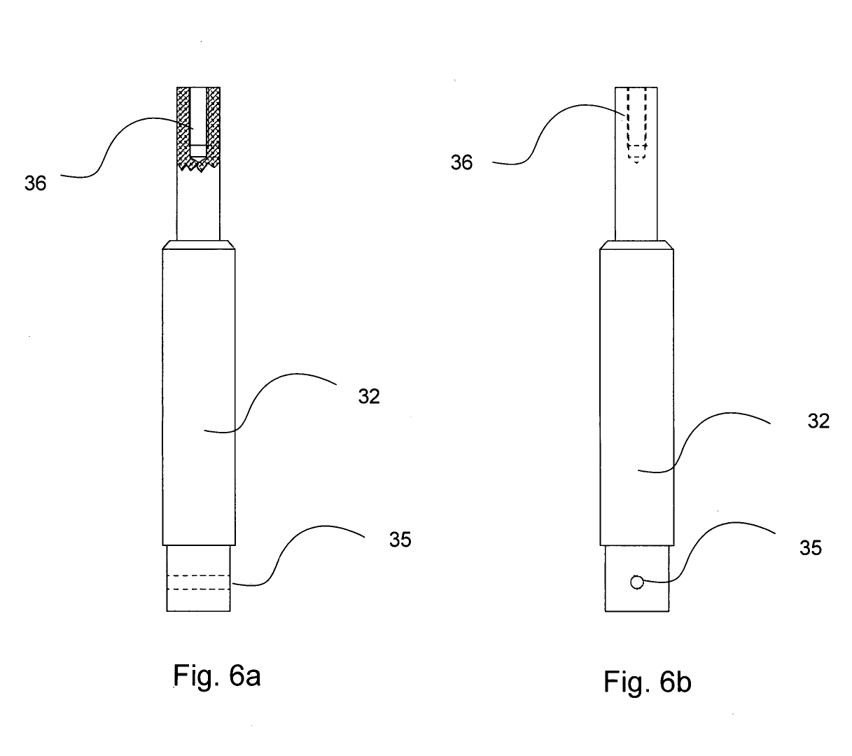

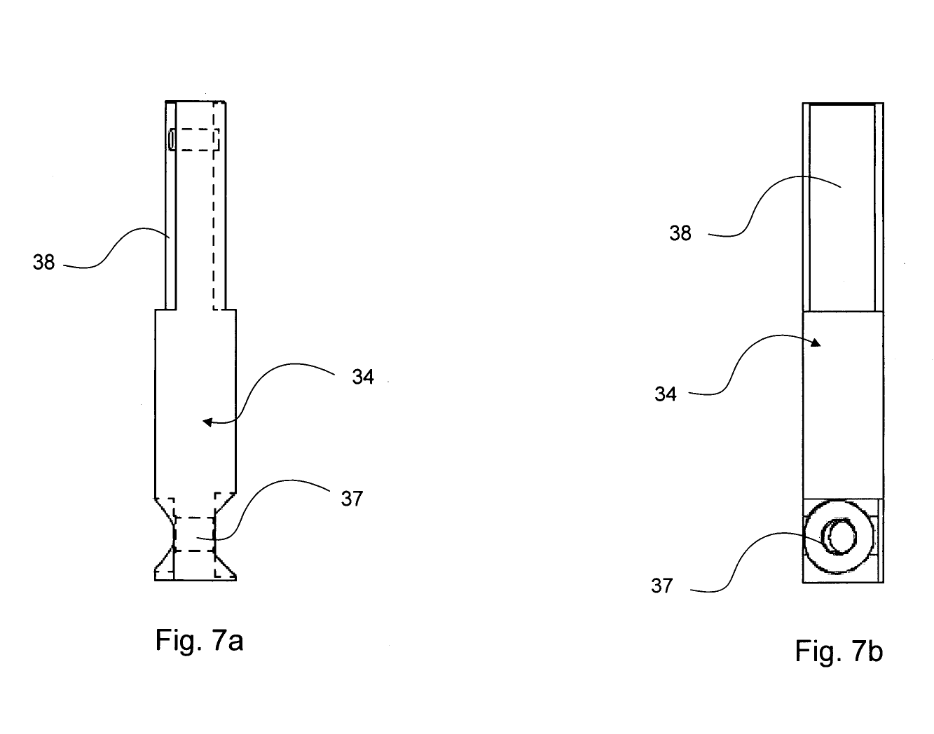

FIGS. 6a, 6b, 7a and 7b illustrate details of an embodiment of the rear support 30.

The rear anchor 32 is configured to be inserted into the second structural hard point 70 and includes a passage way 35 that is configured so that the rear anchor 32 may be bolted to the second hard structural point 70 (FIG. 3). On the other end of the rear anchor 32 a threaded hole 36 is provided and is configured to accept a screw or double-sided threaded stud. The horizontal stand 34 includes a hole 37 configured to be fastened to the rear anchor 32. The horizontal stand 34 also includes a flattened section 38 that may be configured to be the shape of a standard support bar on a rack.

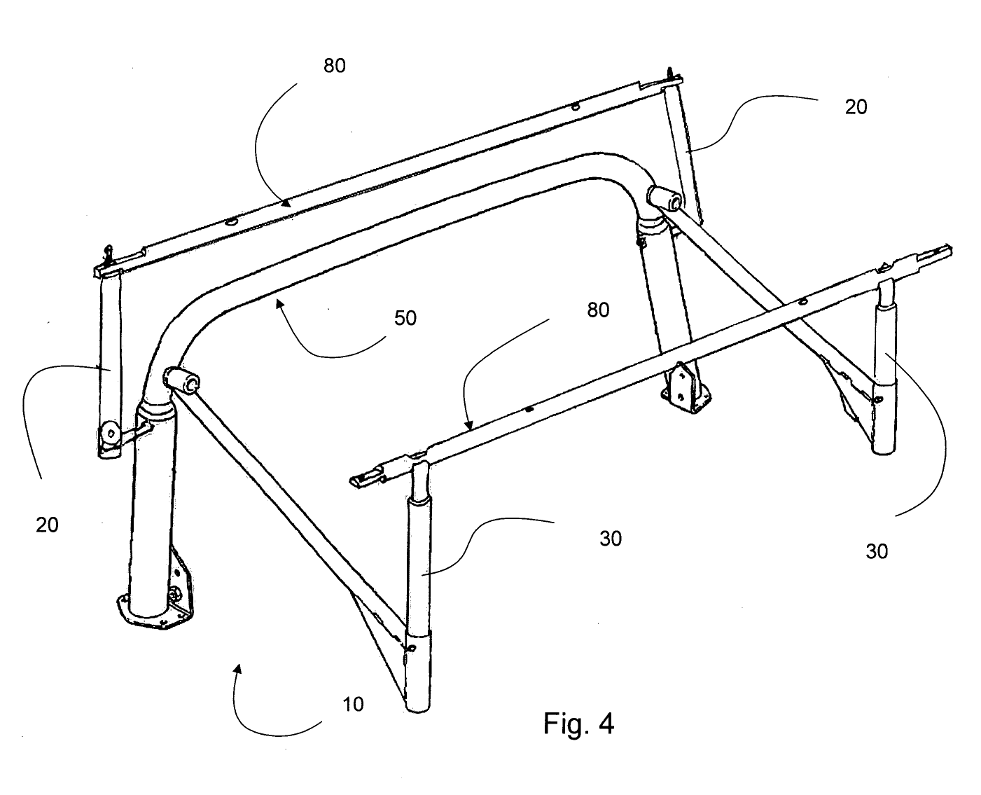

Looking next at FIG. 4, an exemplary embodiment of an accessory rack according to an aspect of the present invention is illustrated. As depicted, a first front support 20 is mounted to the frame 50 opposite a second front support 20 that is also mounted to the frame 50. A bar 80 joins the two supports 20. Similarly, a first rear support 30 is mounted to the frame 50 opposite a second rear support 30 and the bar 80 connects the two rear supports 30 together. Thus, the bars 80 provide a larger platform for mounting carriers to the accessory rack 10 and may also be configured to support greater amounts of weight as compared to the accessory rack configured to mount to just one side of the vehicle. In an embodiment the bars 80 will be configured to accept standard sized carriers.

It should be noted that the embodiment depicted in FIG. 4 has an advantage over traditional roof mounted rack systems because it mounts to the frame and, therefore, will generally provide a more secure mounting. Accordingly, the accessory rack 10 may be more readily configured to support higher weight limits.

As can be appreciated, the components of the accessory rack 10 preferably will be manufactured out of a suitable material that is both light and strong. For example, but without limitation, aluminum or titanium or steel alloys may be used. If an aluminum alloy such as 7075-T651 is used it may be beneficial to anodize or powder coat the aluminum components if there is any interface with other metals so as to minimize corrosion that is caused by the interaction between dissimilar metals. If multiple components are used to form the front and rear support, it may be advantageous to use a steel fastener to join the components.

In an embodiment, the accessory rack 10 may be mounted to an LOTUS ELISE. This would be beneficial because existing accessory racks cannot be mounted on a LOTUS ELISE. The accessory rack 10 may be mounted to an existing hole (e.g. structural hard point 65) and an existing recess (e.g. structural hard point 70) as depicted in FIG. 3. These structural hard points may be prepared as needed. For example, an existing hole may be threaded and additional holes may be added as need to provide additional mounting points and/or cotter pin type restraint. In an alternative embodiment, the accessory rack 10 may be configured to be mounted on different structural hard point and on a different vehicle.

It should be noted that while it may not be required, it is expected that at least a portion of the front support 20 and rear support 30 will be modified if the accessory rack 10 is to be installed on a different vehicle.

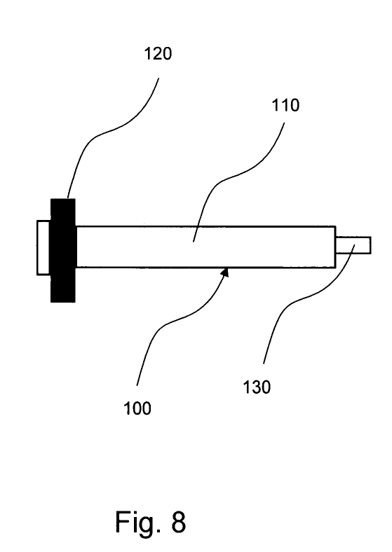

As depicted in FIG. 3, the front support 20 includes the front anchor 22 and the vertical stand 24. It should be noted that these components may themselves consist of subcomponents. For example, the front anchor 22 may be a two-piece construction where one of the pieces may be removed. This may allow the removal of the piece that extends through the body 7 (FIG. 1) so that it may be replaced with a substitute piece that seals to and is relatively flush with the body 7 (see FIG. 8). Numerous other configurations are possible.

One thing to note is that mounting the accessory rack will make a slight change to the vehicle geometry and will also extend out from the vehicle. While the accessory rack is reasonably attractive, it may be desirable to provide a faux anchor to fill in the hole in the body while providing a substantially flush look when the anchor is not installed.

FIG. 8 provides an embodiment of a faux anchor 100. While numerous other designs are possible and the desired design would depend on the configuration of the body and the frame, as depicted the faux anchor 100 includes a body 110, a grommet 120 and a threaded stud 130. In an alternative embodiment, the faux anchor may be replaced with a flat plug.

In operation, the front and rear supports 20, 30 may be removed and the faux anchor 100 may be installed. Alternatively, the vehicle may be provided with the faux anchor 100 installed and its removal will allow the supports 20, 30 to be installed.

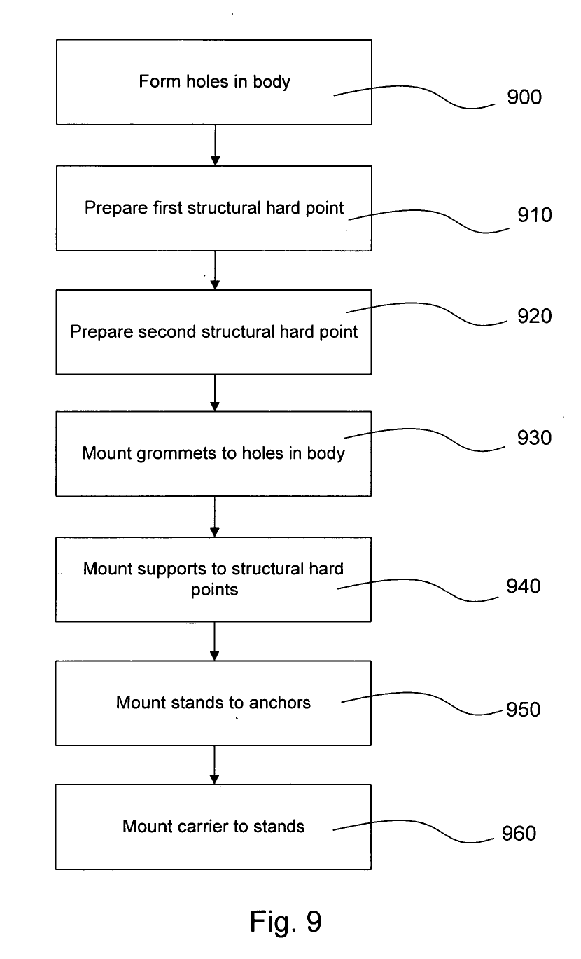

While various methods are possible, FIG. 9 depicts one possible method that may be used to install the accessory rack 10 to the vehicle 1. In step 900, holes are formed in the body as needed. In an embodiment, two holes are formed near the first and second structural hard points. Depending on the vehicle and the frame and the resultant aesthetics, this location may vary as desired. It may be advantageous to locate the holes in substantially the rear half of the vehicles body because this may potentially reduce the propagation of noise into the vehicle compartment.

In step 910, the first structural hard point is prepared to accept the front support. This may include threading an existing hole in the frame or may include drilling a hole in the frame and threading it or some other method of preparation. In step 920, the second structural hard point is prepared to support the rear support. As in step 910, the preparation of the second structural hard point may vary depending on the configuration of the second structural hard point.

Next, in step 930, grommets are mounted to the holes in the body. It should be noted that in alternative embodiments the grommets may be installed after the supports are mounted to the structural hard points. In an alternative embodiment, the grommets may be incorporated into the supports and step 930 may be eliminated. It should be noted that the grommets may be made of one or more pieces and as the use of grommets to seal two adjacent surfaces is generally known, no further details will be provided herein.

In step 940, the front support and rear support are mounted to the structural hard points. This may include, for example, inserting a doubled-sided stud into a threaded hole and then attaching an anchor to the stud. Of course, depending on the configuration of the supports and the holes in the body and the body itself, the supports may also be one piece or more than two piece construction. In the event that either the front or rear supports are two or more piece units comprising an anchor and stand, in optional step 950 the stand(s) is/are mounted to the anchor(s).

In optional step 960, a carrier is mounted to the stands. Step 960 may be eliminated by the inclusion of a carrier into the stands. However, as a more generic stand may accept a variety of carriers, it is generally preferable to have the carrier by a separate component. In an embodiment, the stand may provide standard sized mounting surfaces configured to interact with standard carriers such as those provided by, for example but without limitation, YAKIMA or THULE.

It should be noted that when multiple components are used, such as an anchor and a stand, the geometries of the various components may be configured so that the components align together in a secure and integrated manner. It is further noted that the components depicted in FIG. 3, while configured for mounting to a first side of the vehicle, may also be configured to mount to the opposite side of vehicle. In an embodiment, the front support may include an anchor and a stand and the anchor may be configured to be used on either the left or right side of the vehicle. When designing the accessory rack it is desirable to configure it so that the trunk and other access doors and/or panels are still readily accessible while the accessory rack is installed. This issue is typically less of a concern for designs using the half rack depicted in FIG. 3 rather than the full rack depicted in FIG. 4.

The present invention has been described in terms of preferred and exemplary embodiments thereof. Numerous other embodiments, modifications and variations within the scope and spirit of the appended claims will occur to persons of ordinary skill in the art from a review of this disclosure.

We claim:

1. An accessory mounting system for mounting to a vehicle having a body with a roof, first side, a second side, a front and a rear, the vehicle including a first structural hard point, the vehicle further including a second structural hard point positioned rearward of the first structural hard point; the accessory mounting system comprising:
a first support configured to mount to the first structural hard point of the vehicle, wherein the first support extends through the body of the vehicle;
a second support configured to mount the second structural hard point of a vehicle, wherein the second support extend through the vehicle body, whereby the first and second support are configured to operatively support a carrier.

2. The accessory mounting system of claim 1, wherein the first and second support are configured to support a bicycle carrier.

3. The accessory mounting system of claim 1, wherein the first support and the second support are configured to support the carrier substantially to the side of the roof of the vehicle.

4. The accessory mounting system of claim 1, wherein the first and second support are configured to support the carrier at a height below the roof of the vehicle.

5. The accessory mounting system of claim 1, further comprising a first grommet and a second grommet, the first grommet configured to seal the first support to the body and the second grommet configured to seal the second support to the body.

6. The accessory mounting system of claim 1, wherein the first support is mounted to the frame in a substantially horizontal orientation and the second support is mounted to the second structural support in a substantially vertical orientation.

7. The accessory mounting system of claim 1, wherein the vehicle is a Lotus Elise.

8. An accessory mounting system for mounting to a vehicle having a frame and a body with a roof supported by the frame, the frame supporting a first structure hard point and a second structural hard point; the mounting system comprising:
a first support configured to mount to the first structure hard point, the first support configured to extend through the body;
a second support configured to mount to the second structural hard point, the second support configured to extend through the body;
a first grommet for sealing the first support to the body; and
a second grommet for sealing the second support to the body.

9. The mounting system of claim 8, wherein the first structural hard point is provided on a roll bar.

10. The mounting system of claim 9, wherein the second structural hard point is provided on a member supporting the roll bar.

11. The mounting system of claim 8, wherein the first support comprises a first anchor and a first stand and the second support comprises a second anchor and a second stand.

12. The mounting system of claim 8, wherein the first anchor is configured to be installed substantially horizontal and the second anchor is configured to be installed substantially vertical.

13. The mounting system of claim 8, wherein the first and second support are configured to support a carrier substantially on the first side of the vehicle.

14. The mounting system of claim 11, wherein the first support further comprises a first double-sided stud and a second double-sided stud.

15. The mounting system of claim 8, wherein the first and second support are configured to support a carrier at a height below the roof of the vehicle.

16. An accessory mounting system attached to a vehicle, the vehicle including a first side, a second side, a rear, a frame and a body supported by the frame, the mounting system comprising:
a first support mounted on the first side of the vehicle to a first structural hard point supported by the frame, the first support extending through the body of the vehicle;
a second support mounted on the first side of the vehicle to a second structural hard point supported by the frame, the second support extending through the body of the vehicle, wherein the second structural hard point is positioned between the rear of the body and the first structural hard point, wherein the first and second support are configured to support a carrier;
a first grommet positioned between the first support and the body; and
a second grommet positioned between the second support and the body.

17. The mounting system of claim 16, further comprising:
a third support mounted on a second side of the vehicle to a third structural hard point supported by the frame; the second support extending through the body of the vehicle;
a fourth support configured to mount on the second side of the vehicle to a fourth structural hard point support by the frame, the fourth support configured to extend through the body of the vehicle and positioned rearward of the third support;
a third grommet positioned between the third support and the body;
a fourth grommet positioned between the fourth support and the body;
a first bar connecting the first and third supports; and
a second bar connecting the second and fourth supports.

18. The mounting system of claim 16, wherein the first support comprises a first anchor configured to mount substantially horizontally to the first structural hard point and wherein the second support comprises a second anchor configured to mount substantially vertically to the second structural hard point.

19. The mounting system of claim 18, wherein the first support further comprises a substantially vertical stand and the second support further comprises a substantially horizontal stand, the substantially vertical stand mounted to the first anchor and the substantially horizontal stand mounted to the second anchor.

20. The mounting system of claim 19, wherein the first support further comprises a double-sided stud, the double-sided stud connecting the substantially vertical stand and the first anchor of the first support and wherein the vehicle is a Lotus Elise.
